(19) United States
(12) Patent Application Publication
(10) Pub. No.: US 2012/0247946 A1
(43) Pub. Date: Oct. 4, 2012

(54) MONOLITHIC PHOTOCATALYST SYSTEM FOR GENERATING ELECTRICITY

(75) Inventors: Sigrid Obenland, Munich (DE); Christian Fischer, Pohlheim (DE); Harald Natter, Saarbruecken (DE)

(73) Assignee: CFSO GMBH, Greifenberg (DE)

(21) Appl. No.: 13/389,397

(22) PCT Filed: Aug. 9, 2010
(86) PCT No.: PCT/EP2010/004860

§ 371 Date: Jun. 19, 2012

(30) Foreign Application Priority Data
Aug. 9, 2009 (DE) 10 2009 036 180.4

(51) Int. Cl. B01J 19/12; C01B 3/04; C01B 13/02

(52) U.S. Cl. 204/157.5; 422/162

(57) ABSTRACT

Described is a monolithic catalyst system (1) for the cleavage of water into hydrogen and oxygen with the aid of light, comprising a first photoactive material (50) capable by itself or together with one or more auxiliary catalysts when irradiated with light having a wavelength ≧420 nm of generating oxygen and protons from water, and a second photoactive material (60) capable by itself or together one or more auxiliary catalysts (92) when irradiated with light having a wavelength ≧420 nm of reducing protons in water to hydrogen, the first photoactive material (50) and second photoactive material (60) being in electrical contact via one or more electron-conducting materials (30, 20, 40, 60a) the system being in that characterized in that a load or an electric consumer is interposed in between at least one electron-conducting material. Likewise described is a method of generating oxygen, hydrogen and electricity from water using the catalyst system.

### BACKGROUND OF THE INVENTION

The invention relates to a photocatalyst system for the cleavage of water into hydrogen and oxygen with the aid of light, which simultaneously generates electricity, and to a method of producing hydrogen, oxygen and electricity using the catalyst system.

### PRIOR ART

Hydrogen is generally believed to become the material energy carrier of the future and thus there is a major interest in the environmentally friendly production of hydrogen without the concomitant production of carbon dioxide and without the use of conventional electrolysis which usually is expensive and often environmentally unfriendly.

When electricity is generated photoelectrochemically, conventionally photovoltaic cells (solar cells) are used.

Wo 2009/056348 describes a monolithic photocatalyst system for the cleavage of water into hydrogen and oxygen.

### SUMMARY OF THE INVENTION

The present invention provides a monolithic catalyst system for the cleavage of water into hydrogen and oxygen with the aid of light, comprising a first photoactive material capable by itself or together with one or more auxiliary catalystss when irradiated with light having a wavelength ≧420 nm of generating oxygen and protons from water, and a second photoactive material capable by itself or together one or more auxiliary catalysts when irradiated with light having a wavelength ≧420 nm of reducing protons in water to hydrogen, the first photoactive material and second photoactive material being in electrical contact via one or more electron-conducting materials, characterized in that a load or an electric consumer is interposed in between at least one electron-conducting material.

Also provided is a method of generating oxygen and hydrogen from water with the aid of light and a catalyst system which is characterized in that a catalyst system in accordance with the invention is brought into contact with water or an aqueous fluid or solution at a first location comprising a first photoactive material or one or more auxiliary catalysts associated therewith and which is brought into contact with water or an aqueous fluid or solution at a second location comprising the second photoactive material or one or more auxiliary catalysts associated therewith and is then irradiated with light, the water or aqueous fluid or solution in contact with the first location and the water or aqueous fluid or solution in contact with the second location being in contact with each other such that protons can migrate from the first location to the second location, characterized in that the electric current which flows between the first and the second photoactive materials is used for operating a load or an electric consumer.

Advantageous embodiments of the invention are recited in the dependent claims.

### BRIEF DESCRIPTION OF THE DRAWINGS

FIG. 1 depicts the so-called the Z scheme of photosynthesis or photolysis of water in plants or bacteria as used in the catalyst system in accordance with the invention.

FIG. 2 depicts a diagrammatic cross-section through an example of a photocatalyst system in accordance with the invention.

Principle of Generating Hydrogen and Oxygen According to the So-Called Z-Scheme

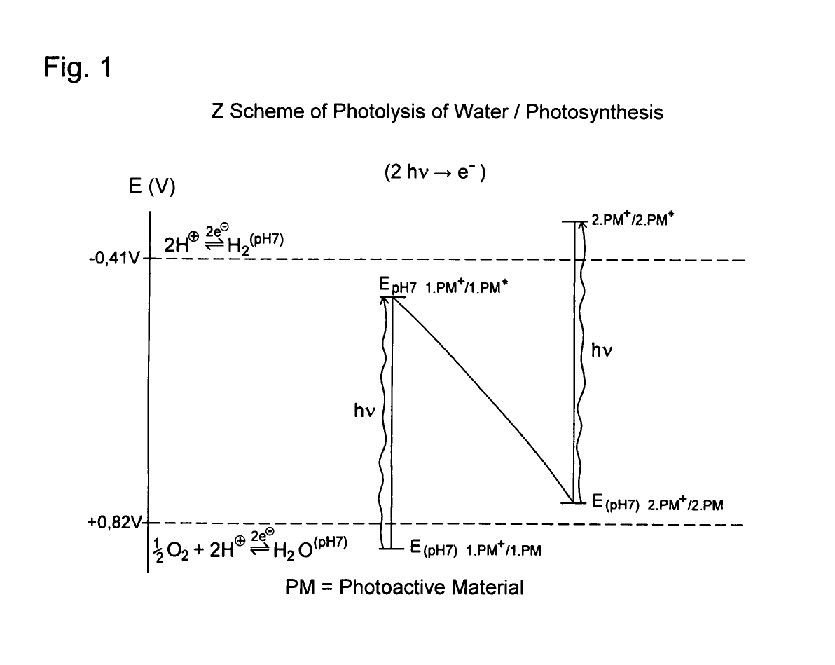

The catalyst system of the present invention uses four photons for the cleavage of water into ½ O₂ and H₂. The various partial steps and how they relate by their energy levels are depicted diagrammatically in FIG. 1.

Required at the oxidizing side of the catalyst system (also termed first photoactive material hereinafter) are 2 photons for the following reaction

H₂O+2 photons→½ O₂+2 H⁺+2 e⁻(E_{O2/H2O(pH7)}=+0.82 V).

This is the reaction that takes place in plants/bacteria in the so-called photosystem 2.

Required at the reduction side of the catalyst system (also termed second photoactive material hereinafter) are 2 photons for the following reaction

2 H⁺+2 e⁻+2 photons 4 H₂ (E_{H+/H2(pH7)}=−0.41 V).

This is the reaction that may take place in some bacteria in the photosystem 1 in conjunction with the enzyme hydrogenase that generates hydrogen.

The net result of this reaction is:

H₂O+4 Photonen→H₂+½ O₂ (E_{pH7}=1.23 V).

What is involved is thus a process in which 2 photons (2 hν) are needed so that 1 e⁻ is removed from the oxygen in water and transferred to a H⁺ ion (2 hν→1 e⁻). This reaction is also termed Z scheme reaction according to photosynthesis in plants and bacteria.

The terms “hydrogen”, “protons”, “H⁺”, “H⁺ ions” etc. in conjunction with the present invention are also intended to include the terms “deuterium”, “deuterium ions”, “D⁺”, “D⁺ ions” etc. Likewise the term “H₂” is also intended to include “HD” and “D₂”. However, the term “D₂” does not include “HD” and “H₂”.

The electric current, I.e. the electrons set free at the oxidation side of the catalyst system (in the terms of electrochemistry: the anode) in accordance with the invention are conducted directly to the reduction side of the catalyst system (in the terms of electrochemistry: the cathode) via one or more electron-conducting materials. Ion conductors, fluid redox electrolytes and solid electrolytes are not included in the term “electron-conducting material”. Electron conduction through junctions such as a p-n junction is not considered to involve an electron conducting material between a first and a second photoactive material in the sense of the present invention. In at least one electron-conducting material a load or electric consumer is interposed.

The invention imitates the Z scheme of plants and bacteria also in regards to the direct electron conduction between the two photoactive materials. Thus, it truly artificially mimics photosynthesis in plants and bacteria or, more precisely, the photolysis of water in some bacteria, i.e. can truly be considered to achieve artificial photosynthesis.

Of course, no external voltage has to be applied to the system in order to function.

A monolithic catalyst system whose sites which comprise the two photoactive materials are not separated by a gap is herein understood to be a system which is compact and has no structures such as macroscopic wires, conductors or electrodes extending from the system and not compactly integrated therein, e.g. no electrodes which are connected to the system via a conductive wire, band or sheet or the like, except for the leads or wires leading to the load. Such a monolithic system may take the form of a plate, a film or also a tube. “Monolithic” is not intended to mean that the system is necessarily fabricated as a single piece.

A “photoactive material” is understood in this patent application to be a material which together with a further photoactive material shows a redox potential scheme corresponding to the Z scheme of the photosynthesis/photolysis, the total potential difference of which is sufficient to permit cleavage water into hydrogen and oxygen when the photoactive materials are irradiated with light having a wavelength ≧420 nm, preferably ≧430 nm, more preferably ≧440 nm and particularly ≧450 nm. Furthermore, preferably one or both of the photocatalysts should not exclusively absorb electromagnetic radiation at wavelengths ≧700 nm.

As evident from the Z scheme (see FIG. 1) the redox potentials of the first and second photoactive material comprise the following redox potentials and redox potential relationships:
1. The redox potential of the ionized state of the first photoactive material and the redox potential of the positively charged valence band of the first photoactive material, respectively, is more positive than +0.82 V.
2. The redox potential of the excited state of the second photoactive material and the redox potential of the conduction band of the second photoactive material, respectively is more negative than −0.41 V.
3. The redox potential of the excited state of the first photoactive material and the redox potential of the conduction band of the first photoactive material, respectively, is more negative than the redox potential of the ionized state of the second photoactive material and the positively charged valence band of the second photoactive material, respectively.

The redox potential of the non-excited state of the first photoactive material and of the valence band of the first photoactive material, respectively, is, as a rule more positive than the redox potential of the non-excited state of the second photoactive material and of the valence band of the second photoactive material, respectively.

Since the catalyst system is required to work with visible light having a wavelength ≧420 nm, the excited states and the conduction bands, respectively, of the photoactive materials must permit being generated or occupied with the aid of light of such a wavelength.

The term “a first photoactive material” (which in the terms of electrochemistry is the anode of the photocatalyst system or forms part thereof) and “a second photoactive material” (which in the terms of electrochemistry is the cathode of the photocatalyst system or forms part thereof) is understood to also mean a plurality (or a mixture) of first photoactive materials and second photoactive materials, respectively.

A variety of materials, both in the form of non-molecular solids as well as molecular and polymer compounds, is known which may serve as the first photoactive (oxidation-promoting) material and work in light having a wavelength ≧420 nm. The first photoactive (oxidation-promoting) material may, however without being limited thereto, comprise an optionally doped oxide- and/or sulfide-containing material, in particular RuS₂, complexes or clusters containing a noble metal or an transition metal, and photoactive polymeric materials. For example and without limitation, use may be made of RuS₂ which may be doped, WO₃, which may comprise a noble metal, an iron oxide, which may be doped with foreign atoms, TiO₂ doped with Sb/M (M=Cr, Ni and/or Cu), a Mn₄ cage complex, a Ru₄ cluster complex, a Ru³⁺ complex and the specific photoactive materials described in examples 1, 2 and 3 of the present application.

It is often the case that the individual mechanistic steps resulting in release of electrons from the oxygen of water are not known precisely. But in any case an electronically excite state is created with the aid of a photon having a wavelength ≧420 nm, the excited electron when spatially separated from the first photoactive material leaves behind therein an oxidation state elevated by 1 or a hole which is filled by an electron of the oxygen of the water so that ultimately O₂ and protons are generated, it often being the case that also 2, 3 or 4 (additional) positive charges or holes are generated simultaneously.

To facilitate development of oxygen the first photoactive material may be associated with an auxiliary material and/or catalyst which itself is not a photoactive material as defined above, it instead promoting oxygen development without being able to develop oxygen by itself under irradiation. Such auxiliary materials and/ or catalysts are without limitation e.g. RuO₂, certain noble metals, such as palladium or platinum, or a compound formed in situ from cobalt metal and a phosphate in water.

In use of the catalyst system either the first photoactive material or the auxiliary material and/or catalyst, where existing, or both are in contact with water.

For the second photoactive (reduction promoting) material too, a wealth of materials exists, both in the form of non-molecular solids as well as solid molecular and polymer compounds which absorb in the wavelength range ≧420 nm, all of which may be used. For example, such a material may be one of the many ruthenium(II) complexes most often complexed with nitrogen-containing ligands, of which it is known that they when excited with light of a wavelength ≧420 nm can reduce protons in water (more precisely hydronium ions; often briefly termed herein as “H⁺”) to H₂, usually in conjunction with a common catalytic species which when supplied with electrons can reduce protons to hydrogen, e.g. Pd or Pt. Many other metal-containing complexes too, e.g. noble metal complexes, natural chlorophyll (with Mg as the central atom), Cu-chlorine and Cu-2-α-oxymesoisochlorine or other metal-containing phthalocyanines or metal-containing porphyrines or purely organic compounds having an extended π system, such as among others H₂-chlorine and proflavine exhibit excited states when irradiated with visible light which have sufficient energy to permit reduction of H⁺ to ½ H₂ where necessary with further conductive transfer of the excited electrons causing charge separation to a suitable auxiliary material or catalyst (e.g. Pd, Pt, Ru or a zinc-containing species).

Also a great variety of (where necessary doped) oxide- and oxynitride-containing materials, and, although usually less preferred, phosphide-, arsenide-, antimonide-, sulphide- and selenide-containign materials (e.g. SrTiO₃ doped with Cr/Sb or Rh, ZnIn₂S₄, TaON and NiM₂O₆ (M=Nb, Ta) can generate H₂ from water (where necessary in the presence of an auxiliary material or catalyst such as Pt, Pd or Ru) when irradiated with light ≧420 n nm. In addition, photosemiconducting polymers can employed exhibiting, where necessary in conjunction with a further organic non-polymer material, photovoltaic properties.

Exemplary specific photoactive materials are described in examples 3, 4 and 5 of the present application.

When employing the photocatalytic system of the invention likewise either the second photoactive material or the corresponding auxiliary material or catalyst, if present, or both are in contact with water.

In accordance with the invention the first photoactive material is preferably not the complete photosystem 2, possibly modified, of plants or bacteria, (which thereby split water into oxygen and protons). It preferably particularly does not comprise polypeptides or proteins. The reason is that the natural photosystem 2 is very unstable.

In accordance with the invention the second photoactive material it is presently preferred not to be the complete photosystem 1, possibly modified, of plants or bacteria (which thereby convert (reduce) NADP⁺ into NADPH⁺H or reduce protons to hydrogen by the aid of hydrogenase in special cases). It preferably particularly does not comprise polypeptides or proteins. The reason is that hydrogenase is very sensitive to oxygen and that it might be difficult to couple different auxiliary catalysts for the reduction of protons to the complete photosystem 1.

Although in principle useful, the first photoactive material is preferably not a single crystal or derived therefrom by doping. Single crystals, doped crystals grown by epitaxy and the like are expensive to manufacture.

For the same reason the second photoactive material is preferably not a single crystal or derived therefrom by doping, though such material is useful in principle.

It further is preferred that neither of the photoactive materials is doped silicon, since this material is also expensive.

Preferably in the present invention, not both photoactive materials i.e. either the first photoactive material or the second photoactive material, are conventional semiconductors or photosemiconductors used in photovoltaics, such as III-V semiconductors, II-VI semiconductors or II-V semiconductors or III-VI semiconductors or similar semiconductors that may include mono-, di- and/or trivalent cations of the transition metals and group Va and VIa anions of the periodic table of elements. It is furthermore preferred that none of the two photoactive materials is selected from the above-mentioned semiconductors. Such semiconductors are in principle useful, however they often are expensive, include metals that are environmentally harmful and/or are not stable in the presence of water and in that case may develop poisonous gases.

Preferably the combination of the first and second photoactive materials is not a combination of a semiconducting oxide absorbing the blue and green portion of the solar emission spectrum and of a mesoporous photovoltaic film using the yellow, red and near infrared portion of the solar emission spectrum for proton reduction, as long as the two materials are arranged in sequence so that yellow, red and near infrared light not absorbed by the first photoactive material is transmitted to the second photoactive material. Such an arrangement usually requires a specific tandem cell built for the cleavage of water which is not preferred in the present invention.

Preferably the first photoactive material and the second photoactive material are different chemical species and furthermore preferably do not consist of the same elements.

The first and second photoactive material can be combined in accordance with the Z scheme (see above).

When the second photoactive (reduction-promoting) material is irradiated with light an electron thereof moves to an excited state from which—when the energy is sufficient—it is transferred to protons in the water (often with the aid of an auxiliary material or catalyst, e.g. Pt or Ru) resulting in hydrogen and a photoactive reduction-promoting material or second photoactive material with a hole or an oxidation state elevated by 1, respectively.

The cycle is closed by an excited electron from the first photoactive material reduces the oxidized second photoactive material.

In one concrete case by way of example of a suitable Ru(II) complex when excited, can transfer its electron (where necessary via an auxiliary material and/or catalyst) to a proton and becomes itself oxidized into the Ru(III) complex which can abstract, via an electron-conducting material, an electron from a suitable excited oxidation-promoting material, e.g. RuS₂, thereby closing the electrical circuit for cleaving water. The pH of the water remains constant, since resulting protons are reduced continuously.

To avoid a radiating or radiationless deactivation or electron hole recombination of the excited first and second photoactive material it may be wanted to provide an adjacent electron acceptor material effecting an as much as possible irreversible charge separation which, where necessary, can relay the charge (the electron). Such a material may involve without being restricted thereto e.g. nanocrystalline titanium dioxide or In₂O₃ doped with tin, an organic acceptor compound, such as a quinone or methyl viologen, gold or a further complex compound which can relay electrons e.g. via molecular wires.

In the context of this invention an auxiliary material and/or catalyst is defined as a material which either promotes the transfer of electrons from oxygen (e.g. RuO₂, Pt, or a compound formed in situ from cobalt or a cobalt containing compound and a phosphate) to the first photoactive material, optionally via a conducting or semiconducting material, or the transfer of electrons from the second photoactive material to protons, optionally via a conducting or semiconducting material (e.g. Au, Pt or Ru). However, it is not photoactive itself, i.e. it is unable to effect cleavage of water without an additional photoactive material.

Electron conduction in the catalyst system in accordance with the invention can be effected with all known electron-conducting materials. Electron-conducting materials are e.g. metals, alloys, semiconductors, conductive oxides, conductive polymers, but also so-called molecular wires (e.g. carbon or hydrocarbon chains or generally covalent bound branched or unbranched chains in a wealth of differing structures which may comprise one or more functional groups and exist in the form of substituents of a chemical compound or independently therefrom and are capable of conducting electrons) or so-called nanowires, [“wires” having a diameter of the order of a nanometer (10⁻⁹ meter) including metallic (e.g. Ni, Pt, Au), semiconducting (e.g. Si, InP, GaN etc) and in the macroscopic state isolating materials (e.g. SiO₂, TiO₂), as well as molecular nanowires composed of repeating units of either an organic (e.g. DNA) or inorganic nature (e.g. Mo₆Sg₉₋ₓIₓ). The electrons may also hop from molecule to molecule in certain material combinations.

In organic compounds or in ligands of complexes one or more of the functional groups thereof may be an optionally protected thiol group and the electron-conducting material to which the optionally protected thiol groups are bound may comprise gold.

For instance, electron conduction from a first to a second photoactive material may take place via the sequence: nanocrystalline titanium dioxide/indium tin oxide (ITO)/copper/gold/molecular wire. Other sequences are conceivable. The electrons from the second photoactive (reduction-promoting) material can likewise be transferred to the proton or hydroniumion by different ways and means. Electron conduction up to the proton may involve an auxiliary catalyst, in which case further electron-conducting material(s) may exist between the second photoactive material and the auxiliary catalyst.

Preferably the conducting material does not exclusively comprise organic molecules or complexes of the kind as is to be found in the natural photosynthesis system.

“Electrical contact” or “direct electrical contact” in conjunction with the present invention means material being in electrical contact exclusively via one or more electron-conducting or relaying materials in the solid state, but not via other materials such as ion conducting materials in a fluid or solid medium or liquid redox electrolytes or solid electrolytes.

When the first (oxidation-promoting) or second (reduction-promoting) photoactive material is an organic molecule or a complex with organic ligand(s) the conduction between the two photoactive materials usually includes an electron transition from an organic to an inorganic material or vice-versa, in the special case of a complex from the central atom of the complex via the ligand(s) to the conductive material or from the conductive material via the ligand(s) to the central atom of the complex.

This is usually no problem in the transition of an electron from the central atom to the ligand, and substituent(s) of the ligand are selected so that they are molecular wires. But the transition of an electron from the ligand or its substituent(s) for example to an inorganic conductor does not occur directly. Here, good results have been attained by introducing functional groups on the ligand or at the end of a ligand substituent capable of interacting with the inorganic material so strongly that electron conduction is possible. A prime example thereof is binding thiols to gold surfaces, although there is a wealth of other such interactions, e.g. those of phosphonic acids, carbon acid anhydrides or silanes to inorganic oxides (see e.g. an review thereof in the article by Elena Galoppini “Linkers for anchoring sensitizers to semiconductor nanoparticles” Coordination Chemistry Reviews 2004 248, 1283-1297).

A complex being the second photoactive material may comprise at least two functional groups, of which at least one is bound to the electron-conducting materials and the other is bound to a further electron-conducting material comprising a chemical species which can reduce protons into water when electrons are supplied.

Some photoactive materials, especially reduction-promoting complexes, are unstable in the simultaneous presence of light, water and oxygen. The present invention proposes a way of avoiding such instability by “casketizing” such material in a transparent inorganic “casket” with the exclusion of water and oxygen, e.g. in a thin transparent “gold casket” with insulating sidewalls. In the latter case e.g. a reduction-promoting complex may comprise at least two functional groups, e.g. thiol groups, one of which, as explained above, serves to ensure electron conduction via the “floor” of the “casket” to the oxidation-promoting photoactive material, and the other serves to provide the conduction e.g. to an alloy type of material, e.g. gold/platinum (the “casket lid”) that catalyzes the production of hydrogen with the aid of the excited electrons released from the central atom of the complex which are relayed via molecular wires to this alloy-type material. It will, of course, be appreciated that other such “casket” or “sandwich” structures are equally suitable.

The first (oxidation-promoting) photoactive material and the second (reduction-promoting) photoactive material may be mounted on or otherwise connected with one or more substrates, e.g. by physical deposition or some kind of by chemical bonding. The substrate may also be coated with an electrically conductive material, on which or with which the first (oxidation-promoting) photoactive material and the second (reduction-promoting) photoactive material may be mounted or otherwise connected, e.g. by physical or chemical deposition or some kind of by chemical bonding. The substrates may be electrically and photo-chemically inert, or not, and may be transparent or translucent (for instance glass) to permit the passage of light not absorbed by the photoactive material directly irradiated, or not. Non-limiting examples for the material of the substrate are optionally coated glass, ceramics, metal or metal alloys, semimetals, carbon or materials derived from carbon and all kinds of inorganic and organic polymeric materials.

With the aid of such a substrate a plane, e.g. plate-shaped, or also a tubular or otherwise appropriately shaped catalyst system can be constructed, e.g. with the photoactive oxidation-promoting material on one side and the photoactive reduction-promoting material on the other side, but also, when suitably structured, also with both materials on the same side. When the substrate is transparent or translucent it may be sufficient to irradiate one side of a plate-type catalyst system to also supply light to the photoactive material at the other side.

When a plane catalyst systems having the photoactive materials on opposite sides, for instance when plate-shaped, are immersed in an aqueous fluid, hydrogen is generated on one side and oxygen on the other. The way in which this is achieved already makes for hydrogen and oxygen being separated spatially, greatly diminishing the risk of an oxygen-hydrogen reaction. Totally separating the hydrogen from the oxygen is achievable by engineering the two photoactive materials totally separated from each other spatially, as is possible by compartmenting a reactor or reactor system into two chambers or into 2-chamber systems by means of a material exclusively permeable for protons and water (e.g. a Nafion® membrane). Protons must be able to drift to and fro between both chambers to compensate the charge.

The aqueous fluid into which the plane e.g. plate-type catalyst system of the present invention is immersed is normally water which may contain, depending on the case concerned, all kinds of soluble salts, acids or bases, but not by necessity. And, of course, e.g. mixtures of solvents and surfactants and the like soluble in water and, where necessary, watery emulsions and the like not involved in the photolysis reaction are a possible medium should it prove necessary, as long as the photolysis of the water is not disturbed or prevented thereby.

The electric current is directed to the load at any convenient first location after the first photoactive material and before the second photoactive material, an from the load at any convenient location second after the first location and before the second photoactive material back into the catalyst system.

The load or electrical consumer may be any device the operation of which require electricity, such as resistance heaters, cooling devices, devices for generating light, electrical motors, loudspeakers, secondary batteries, resistance of any kind, e.g. in volt meters and ampere meters, and the like.

Several photocatalyst systems according to the invention may be connected in series or in parallel for the generation of electricity.

In the method of the invention the light used for irradiating the catalyst systems is preferably sunlight.

Furthermore, the first location and the second location irradiated are preferably separated from each other by a membrane permeable only for protons and water, e.g. a Nafion® membrane.

Only the first location of the catalyst system may be directly irradiated with light e.g. If the system is sufficiently transparent or partly transparent. Alternatively, only the second location may directly irradiated with light. In many cases, both locations are directly irradiated with light.

Oxygen and/or hydrogen evolving from water with the aid of the catalyst system and light may be intermittently or continuously collected.

The photocatalyst system in accordance with the invention has many advantages. Hydrogen and oxygen can be generated separately without production of oxygen-hydrogen gas, and simultaneously the current which is generated is put to use. The system does not take the form of a powder but is monolithic, e.g. in the form of a plate which is simply immersed in an aqueous medium, requiring often no addition of any salts, acids or bases (although this is not excluded) which possibly add to the cost or environmental load of the method, all without the need of any special cells needing to be pressurized or involving a redox electrolyte which has to be encapsulated solvent-proof. The system is extremely flexible, featuring a large choice of water oxidizing catalysts (first photoactive materials) and water (or protons) reducing catalysts (second photoactive materials) enabling suitable combinations to be tailor-made.

Structure of an Exemplary Catalyst System

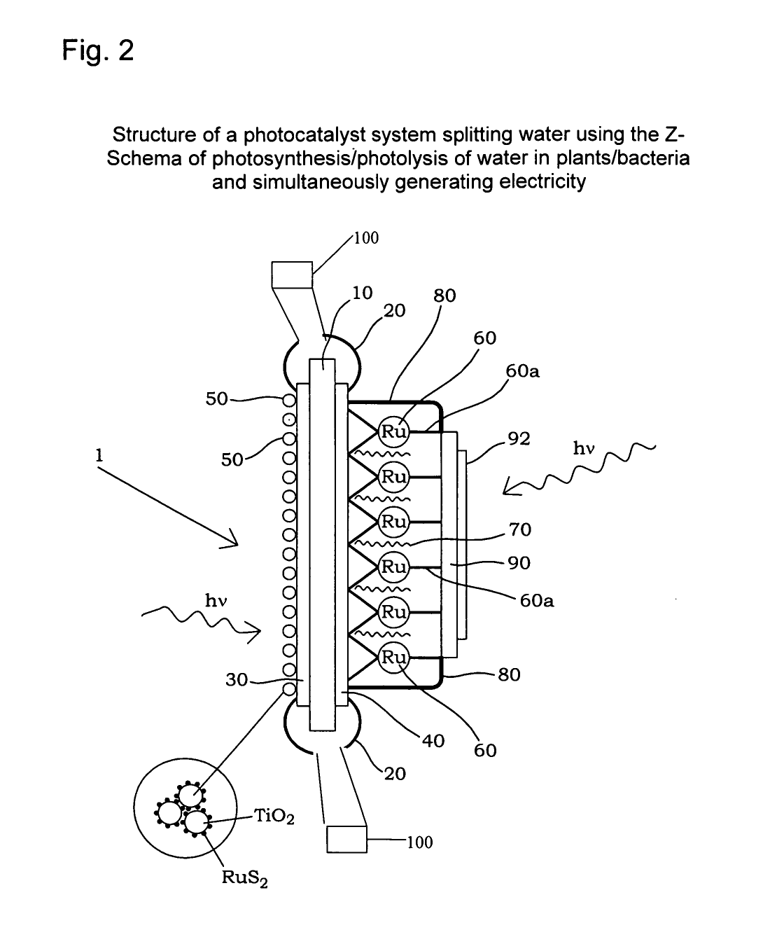

FIG. 2 depicts a diagrammatic cross-section through the configuration of a photocatalyst system 1 working analogously to the Z scheme, which features on one side of an inert plate-type substrate 10 a transparent conductive layer coated with indium doped tin oxide (ITO) 30, on the other side a transparent layer of gold 40. The ITO layer 30 and gold layer 40 are electrically connected by copper bands 20, in between which a load or electrical consumer 100 is interposed.

Sintered on the ITO layer 30 is nanocrystalline TiO₂ 50 coated with RuS₂. Provided on the gold layer 40 is a monolayer of a ruthenium complex 60 (depicted far too thick) with three mercaptoalkyl substituents 60a (see example III.2.b) and an alkylthiol 70. The edges of the monolayer are framed on all sides by a resist 80 extending over the edge of the monolayer and covering the monolayer with a narrow band of resist. Vacuum deposited on the monolayer of the ruthenium complex 60 and alkylthiol 70 is a transparent thin gold layer 90 comprising just a few layers of gold and extending beyond the resist 80. Over the gold layer 90 a platinum layer 92 with fewer atoms of platinum than of a monolayer is deposited.

When the catalyst system as shown in FIG. 2 is immersed in water and irradiated with light having a wavelength ≧420 nm electrons originating from the oxygen atoms of the H₂O which has been oxidized to ½ O₂+2H⁺ migrate from the TiO₂ 50 coated with ruthenium disulfide via the ITO layer 30 and copper bands 20 via the load 100 to the gold layer 40. Since the ruthenium complex 60 on being irradiated has given off an electron to an H⁺ an electron migrates from the ruthenium complex 60 via the thiol group and the alkyl chain of the mercaptoalkyl substituents 60a of the ruthenium complex 60 to its Ru central atom. Irradiation of the ruthenium complex 60 causes it excitation to give off an electron to the gold layer 90 coated with platinum 92 via the alkyl chain and the thiol group of a further mercaptoalkyl substitute 60a and from there via the platinum 92 to a proton (H⁺) in water which is reduced thereby to ½ H₂.

### EXAMPLE S

The invention is further illustrated by the following non-limiting examples.

### Example 1

### A. Preparation of a Oxidation-Promoting First Photoactive Material on TiO₂ in the Form of a 5% Suspension of TiO₂/RuS₂ (2% by Weight RuS₂ Relative to TiO₂)

The preparation of the title material is performed as described in Example 1 WO 2009/056348.

### B. Applying the Above Oxidation-Promoting First Photoactive Material to an ITO Substrate

This procedure is performed as describe in Example 1 A. of WO 2009/056348.

The resulting slide is designated Ox-I.

### Example 2

### A. Tris[4-(11-mercaptoundecyl)-4′-methyl-2,2′-bipyridine]ruthenium(II)-bis-(hexafluorophosphate), a Reduction-Promoting Second Photoactive Material

The preparation of the title material is performed as described in Example 4 A. of WO 2009/056348.

### B. Applying the Above Reduction-Promoting Second Photoactive Material to an Inert Substrate

This procedure is performed as describe in Example 4 B. of WO 2009/056348.

The resulting slide is designated Red-I.

### EXAMPLE 3

### Combination of the Catalyst Units Comprising the First and Second Photoactive Materials into a Catalyst System and Irradiation

3.1 Combining Ox-I and Red-I

Both of the catalyst units (slide Ox-I and slide Red-I) produced in Example 1 and Example 4, respectively, comprising the oxidation-promoting first photoactive material RuS₄ and the reduction-promoting second photoactive material tris[4-(11-mercaptoundecyl)-4′-methyl-2,2′-bipyridine]ruthenium(II)-bis-(hexafluorophosphate), respectively, are bonded together by their non-coated faces and the coated surfaces of the two units are conductively interconnected by a copper conductive adhesive tape (made by PGO Präzisions Glas & Optik GmbH, Im Langen Busch 14, D-58640 Iserlohn, Germany). The gold side of Red-I is then coated with a resist so that the Cu bands and edges of the gold layer and a small band along the edges of the slide containing the complex on the gold layer are covered. After having dried the assembled and conductively connected catalyst units the gold side coated with the complex is again vapor deposited with a very thin gold layer (5 nm) so that also the adjoining resist layer is covered. finally, the catalyst system is completed by coating this gold layer with 0.5-0.7 monolayers (ML) of platinum. The copper conductive adhesive tapes bands are cut into tow parts and each half is attached to a measuring tip of an ampere meter.

3.2 Irradiating the Catalyst System (Ox-I)-(Red-I)

A catalyst system as made in Section 3.1 is immersed into distilled deoxygenated water in such a way that the measuring tips of the ampere meter with the cooper bands adhered thereto are above the water level. Then the catalyst system is irradiated from both sides with a 500 Watt halogen lamp through 420 nm cut-off filters. After heating to about 50° C. hydrogen and oxygen evolve which are detected by gas chromatography. At the same time an electrical in the nanoampere range is measured.

The entire relevant disclosure of all documents cited in the present application, such as e.g. journal articles, books as well as patents and patent applications, is herein incorporated by reference.

1.-15. (canceled)

16. A monolithic catalyst system for the cleavage of water into hydrogen and oxygen with the aid of light, wherein the system comprises a first photoactive material which upon irradiation with light having a wavelength >420 nm is capable by itself or together with one or more auxiliary catalysts of generating oxygen and protons from water, and a second photoactive material which upon irradiation with light having a wavelength >420 nm is capable by itself or together one or more auxiliary catalysts of reducing protons in water to hydrogen, the first photoactive material and second photoactive material being in electrical contact via one or more electron-conducting materials and a load or an electric consumer being interposed inbetween at least one electron-conducting material.

17. The monolithic catalyst system as set forth in claim 16, wherein the wavelength is >430 nm.

18. The monolithic catalyst system as set forth in claim 16, wherein the wavelength is >440 nm.

19. The monolithic catalyst system as set forth in claim 16, wherein the wavelength is >450 nm.

20. The monolithic catalyst system as set forth in claim 16, wherein the system comprises one or more catalysts either in association with the oxygen-generating material or with the hydrogen-generating material or with both.

21. The monolithic catalyst system as set forth in claim 16, wherein the, or at least one of the electron-conducting material(s) comprises a metal or metal alloy or an oxidic electron-conducting material.

22. The monolithic catalyst system as set forth in claim 16, wherein the comprises a substrate.

23. The monolithic catalyst system as set forth in claim 16, wherein the first photoactive material is selected from one or more of an optionally doped oxide- and/or sulphide-containing material, complexes or clusters containing a noble metal or a transition metal, and photoactive polymeric materials.

24. The monolithic catalyst system as set forth in claim 16, wherein the first photoactive material comprises RuS₂.

25. The monolithic catalyst system as set forth in claim 16, wherein the second photoactive material is selected from one or more of a metal-containing complexes, an organic compounds having an extended [pi] system, an oxide- or oxynitride-containing material, a phosphide-, arsenide-, antimonide-, sulphide- or selenide-containing material, and a photosemiconducting polymer.

26. The monolithic catalyst system as set forth in claim 25, wherein the second photoactive material comprises a noble metal-containing complex.

27. The monolithic catalyst system as set forth in claim 26, wherein the second photoactive material comprises a Ru complex.

28. The monolithic catalyst system as set forth in claim 16, wherein either the first photoactive material or the second photoactive material or both are bound by a functional group to the one or more electron- conducting materials.

29. The monolithic catalyst system as set forth in claim 16, wherein the system has a plane multilayer structure, one side of the structure comprising the first photoactive material and the other side of the structure comprising the second photoactive material or one side comprising the first photoactive material and the second photoactive material.

30. A method of generating oxygen and hydrogen from water with the aid of light and a catalyst system, wherein the method comprises contacting a catalyst system according to claim 16 with water or an aqueous fluid or solution at a first location comprising a first photoactive material or one or more auxiliary catalysts associated therewith and contacting the system with water or an aqueous fluid or solution at a second location comprising the second photoactive material or one or more auxiliary catalysts associated therewith and thereafter irradiating the system with light, the water or aqueous fluid or solution in contact with the first location and the water or aqueous fluid or solution in contact with the second location being in contact with each other such that protons can migrate from the first location to the second location, and wherein an electric current which flows between the first and the second photoactive materials is used for operating a load or an electric consumer.

31. The method as set forth in claim 30, wherein the light comprises sunlight.

32. The method as set forth in claim 30, wherein the catalyst system is a monolithic catalyst system, the first location and the second location being separated from each other by a membrane permeable only for protons and water.

33. The method as set forth in claim 30, wherein the first location or the second location is directly irradiated with light.

34. The method as set forth in claim 30, wherein both locations are directly irradiated with light.

35. The method as set forth in claim 30, wherein oxygen and/or hydrogen are intermittently or continuously collected.
